(19) United States
(12) Patent Application Publication
(10) Pub. No.: US 2005/0077740 A1
(43) Pub. Date: Apr. 14, 2005

(54) Ring kit canine waste collection and disposal method

(76) Inventor: Alex William Ciavola, Orange, CA (US)

Correspondence Address: Alex W. Ciavola, 2440 E. Hillside Ave., Orange, CA, 92867, US

(21) Appl. No.: 10/681,592

(22) Filed: Oct. 9, 2003

(51) Int. Cl. A01K 29/00; E01H 1/12

(52) U.S. Cl. 294/1.3

(57) ABSTRACT

A canine waste collection device and waste disposal method are described. The device is called the Ring Kit Canine Waste Collection and Disposal Method. The ring kit device collects canine feces before it contacts the ground and provides a sanitary means to dispose of the collected solid waste. The ring kit device consists of a chrome-plated, 10-inch in diameter, steel ring, a supply of disposable plastic bags, a steel belt clip, and complete instructions for use.

### BACKGROUND OF THE INVENTION

1. Field of the Invention

The present invention relates to a canine waste collection method that prevents any waste material from reaching the ground. The invention also relates to a sanitary means to dispose of the waste material that is collected. The invention further relates to other materials and objects that are combined in kit form as part of the waste collection method.

2. Description of Prior Art

Devices to assist in cleanup of animal waste have been proposed and patented for many years. The few which I have cited pertain only to those that claim to remove all traces of animal waste by catching the waste material before it reaches the ground. In addition, I will point out how each of these patents lack certain characteristics necessary to be a useful and commercially viable product. Most importantly, these patents which I cite in the next few paragraphs all overlook the negative effects and reactions their device will have on the dog.

Furthermore, problems inherent in these patents render them impractical for general use as most are too difficult to manipulate, too cumbersome to carry, and too expensive to manufacture and sell. I point out certain problems found in each of the related patents cited, as follows:

Example 1—U.S. Pat. No. 6,386,605 B1 uses a pole and frame on which a paper bag is attached. The paper bag is threaded through a slot and is not simple to prepare or especially to reload while walking, if it is necessary. Also, this method, as evidenced by the drawings, is not usable with all size dogs, requires time and dexterity to prepare for use, and requires the dog handler to carry this cumbersome pole assembly throughout each walk with the dog.

Example 2—U.S. Pat. No. 6,185,395 uses a long pole with a collection bowl attached. The bowl has a series of covering plates that close over the waste material after it is collected. This method does not describe how the waste material is to be disposed. Also, this method is not usable with all size dogs and would frighten or distract the dogs.

Example 3—U.S. Pat. No. 5,971,452 uses a long bent handle with an elliptical ring attached and around which a plastic bag is wrapped. The waste material is collected in the bag and then disposed of later. The inventor suggests that this method would be useful to a person who is physically handicapped or in a wheelchair. As an experienced dog handler, I can verify that very few handicapped persons would be able to use this device while walking their dogs. Often, dogs start to defecate beyond easy reach with this device, and depending on the position of the dog, the dog handler must move quickly to place the device behind the dog. Finally, this method is not usable with all size dogs and would frighten or distract the dogs.

Example 4—U.S. Pat. No. 5,683,129 uses a long pole handle with a ring holder and bag. The bag collects the waste material which is disposed of later. This device is too large to use with medium size or small dogs. Also, the device is too combersome to carry and to reload during the walk. This device would be too expensive to manufacture and is so large it would frighten or distract the dog.

Example 5—U.S. Pat. No. 5,676,411 uses a long pole handle with a V-shaped frame attached. A plastic bag is held by two support arms and after the waste material is collected, the bag is released by a support clamp to be deposited in the trash. This device is too large to use with most dogs. Also, the device is too combersome to carry and to reload during the walk. This device would be too expensive to manufacture and is so large it would frighten or distract the dog.

Example 6—U.S. Pat. No. 4,852,924 uses a long pole attached to a circular frame with an elastic corded bag to catch the waste material. This device is too large for use with most dogs, and too cumbersome to carry while walking the dog. Also, this device would be too expensive to manufacture and sell. Finally, this device would be most difficult to reload, if necessary, while walking the dog.

Example 7—U.S. Pat. No. 4,236,741 uses a pole with a ring attached. The ring holds a disposable container that catches the animal waste. A lid doses and the device is carried with the contents inside until after the walk. This device is too combersome to carry and certainly would frighten or distract any dog.

3. Benefits of the Ring Kit Method Over Other Animal Waste Collection Devices

a. The Ring Kit Animal Waste Collection Method has no Negative Effect on the Dog.

Owners experienced with walking their dogs know that the animal is most sensitive to danger when excreting. All dogs react quickly to any disturbance or distraction. Therefore, the device must be gently placed behind the dog and must not touch the dog. The ring bag is unnoticed by the dog while defecating and thus has no negative effect on the dog.

b, One Size Fits All Dogs

The Ring Kit Animal Waste Collection Method is designed for use by all dogs from the smallest up to the largest dogs. The ring bag lies flat on the ground and has a thickness of about one inch. This height is not a problem for the smallest or shortest dogs. The 10-inch ring inside the bag provides a large enough surface area to accommodate the droppings of even the largest dogs.

c. No Cumbersome Device to Carry or Manipulate

The ring bag is small and easy to carry. The twisted portion of the bag fits in the palm of the hand. The thumb fits around the ring and there remains enough room in the hand to hold the dog's leash. After use of the first bag, another ring bag can be reloaded in ten seconds during the walk, if necessary. Otherwise, the dog handler can attach the steel ring and belt dip to their belt or pocket to avoid accidental loss of the ring, and continue the walk.

d. No Contact with the Dog's Feces

The bag stretched across the ring forms a flat platform to receive the feces. When the bag is untwisted the bag containing the feces is allowed to drop through the center of the ring. The bag is now inverted and the feces remain inside the bag. The bag is then closed and is ready for disposal in a suitable trash container.

### SUMMARY OF THE INVENTION

This invention introduces two new and unique concepts; the “ring kit” and the “ring bag”. The “ring kit” is the complete package comprised of all elements used to perform the waste collection method. The “ring bag” is formed when the steel ring is installed inside the plastic bag. The ring bag forms the flat platform used to catch the animal waste. Repeated tests and use of the ring bag confirm the design is most effective. The ring was specially manufactured because this type ring is not available for purchase anywhere on the common market.

a. A chrome plated, 10-inch in diameter steel ring was designed and manufactured to meet the requirements for use with the ring bag. The ring was designed to a specific size, weight and appearance. The optimum size of the ring was determined to be 10 inches in diameter. Tests proved this to be the most practical size to collect waste from any size dog, from very large to very small dogs.

b. The minimum weight of the ring was determined by tests to be at least 2.5 ounces as required to hold the bag flat on the ground and in place even to withstand winds of up to 25 mph.

c. The appearance of the ring is very important in that it is chrome plated, noncorrosive, attractive and is to be carried by the dog handler, either by hand or using the belt hook. Whether carried or worn, the attractive ring serves as a display of responsibility by the dog handler of intent not to leave any animal waste behind, while walking the dog.

d. The size of the disposable plastic bag used with the 10-inch ring must be 12×7×14 inches and gusseted to allow sufficient space for the ring to enter and leave the bag in the manner required and to not bind on the ring.

e. The thickness of the disposable bags should be no greater than 1.5 mil to provide a softness required for the ring bag to slip through the ring with the waste collected.

f. The color selected for the disposable plastic bags is to be opaque white to indicate sanitary operations. Also, white is highly visible and may discourage someone who may want to discard the bag irresponsibly in a public area.

g. Instructions provided with the ring kit contain “How to Use” details which are important and facts that may not be obvious to the dog handler.

### BRIEF DESCRIPTION OF DRAWINGS

FIG. 1 is a side view of the plastic bag showing how the steel ring is inserted.

FIG. 2 is a side view of the plastic bag with the ring inside positioned flat across the bottom.

FIG. 3 is a side view of the ring bag after after the sides of the bag have been folded together and twisted two or three times.

FIG. 4 is a side view of the ring bag with the flat side up as it is placed on the ground behind the dog.

FIG. 5 is a side view of the ring bag on the ground as it appears after the canine waste has been deposited.

FIG. 6 shows the ring bag as the folds of the bag are untwisted.

FIG. 7 shows a side view of the ring as the bag containing the dog's waste drops through the center of the ring.

FIG. 8 shows a side view of the dog handler walking with the ring clip and ring attached to a belt or pocket.

FIG. 9 is an actual view of the cardboard backpanel display provided with the ring kit. This panel contains essential information on “How to Use the Ring Kit Canine Waste Disposal Method”.

### DETAILED DESCRIPTION OF THE INVENTION

This invention, known as the Ring Kit Canine Waste Collection Method, can be fully understood after a study of the following description and drawings. The operations performed consist of preparation of the ring bag before the walk, waste collection during the walk, and waste disposal after the walk.

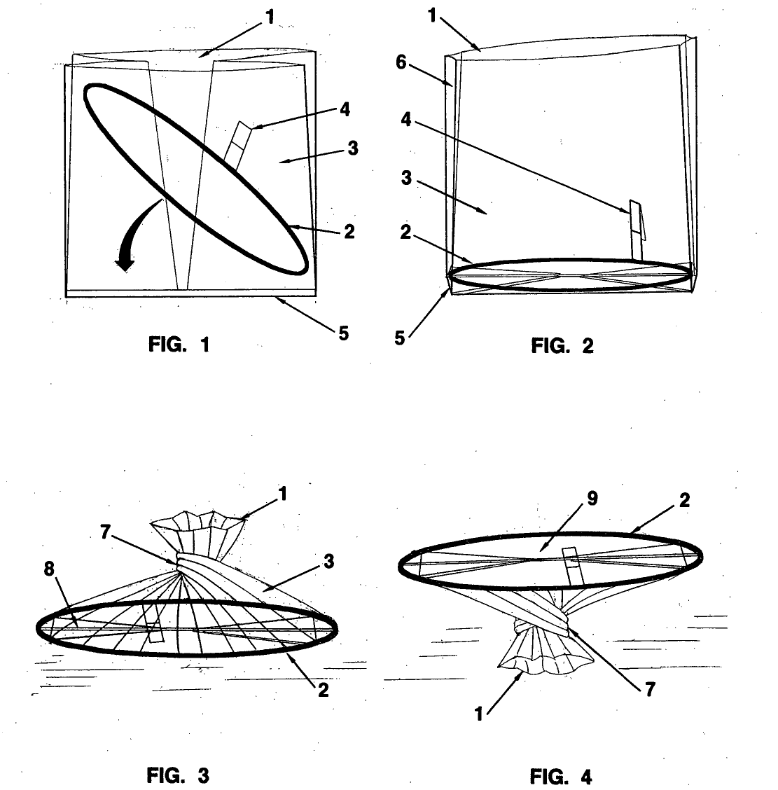

FIG. 1 shows the side view of the ring bag 1 waste collection device. The steel ring 2 is inserted through the top opening of the plastic bag 3. The ring 2 with the belt clip 4 attached is rotated horizontally and pressed to the bottom 5 of the plastic bag 3.

FIG. 2 is a side view of the ring bag 1 showing the steel ring 2 positioned flat across the bottom 5 of the plastic bag 3. The gusset 6 on each side of the plastic bag 3 allows for expansion on the sides. The bottom 5 of the plastic bag 3 forms an oval shape that allows the steel ring 2 to fit easily inside the plastic bag 3, but not fit too tight. The location or position of the belt clip 4, as shown attached to the steel ring 2, is not important and the belt clip 4 does not interfere with the operation of the ring bag 1. The belt clip 4 lies flat on the bottom 5 of the plastic bag 3.

FIG. 3 is a side view of the ring bag 1 after the sides 7 of the plastic bag 3 have been folded together and twisted two or three times. The plastic bag 3 is now stretched across the steel ring 2. The seam 8 of the plastic bag 3 should be located across the center of the steel ring 2, so the waste will be deposited as close as possible to the middle of the plastic bag 3. When the ring bag 1 is carried, the twisted sides 7 of the plastic bag 3 form a convenient handle that fits in the palm of the hand and the thumb fits around the ring 2.

FIG. 4 is a side view of the ring bag 1 with the flat side 9 up, as it is placed on the ground behind the dog. The twisted sides 7 of the ring bag will lie flat on the ground and the steel ring 2 holds the bag in position where placed. The flat upper surface 9 of the ring bag 1 forms a 10-inch wide platform to receive the canine waste.

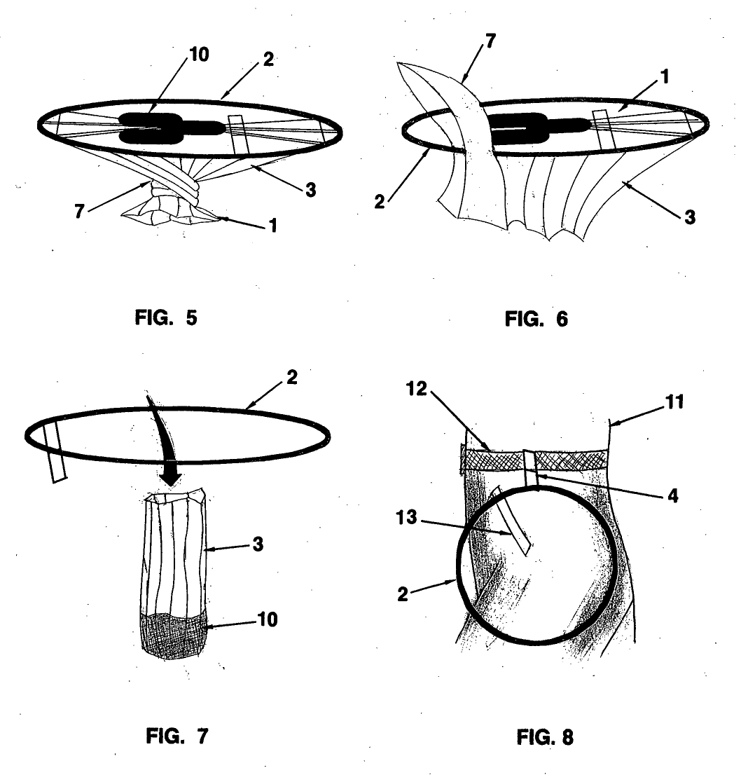

FIG. 5 is a side view of the ring bag 1 as it would appear on the ground after the dog is finished excreting. The ring bag 1 is lifted by grasping the steel ring 2 inside the plastic bag 3 and holding the steel ring 2 parallel to the ground, to prevent dropping some of the canine waste 10. The dog handler should hold the steel ring 2 with one hand and reach under the ring bag 1 to untwist the sides 7 of the ring bag 1.

FIG. 6 shows the ring bag 1 as the sides 7 of the plastic bag 3 are untwisted. The folds of the sides 7 of the plastic bag 3 are lifted up and over toward the center of the steel ring 2. This process is continued around the steel ring 2 until about three-quarters of the plastic folds 7 are lifted up over the edges of the steel ring 2. This process causes the plastic bag 3 to be turned inside out with the canine waste 10 enclosed inside.

FIG. 7 shows a side view of the ring 2 as the plastic bag 3 containing the dog's waste 10 drops through the center of the ring 2. The weight of the dog's waste 10 will carry the plastic bag 3 through the ring 2 and the plastic bag 3 may be allowed to drop onto the ground. The dog handler should pick up the bag 3 and secure the contents for disposal later. The plastic bag 3 with the canine waste 10 inside should be deposited in a suitable trash container after the walk.

FIG. 8 shows a side view of the dog owner or handler 11 walking with the belt clip 4 and ring 2 attached to a belt 12 or pocket 13 to prevent loss of the ring 2.

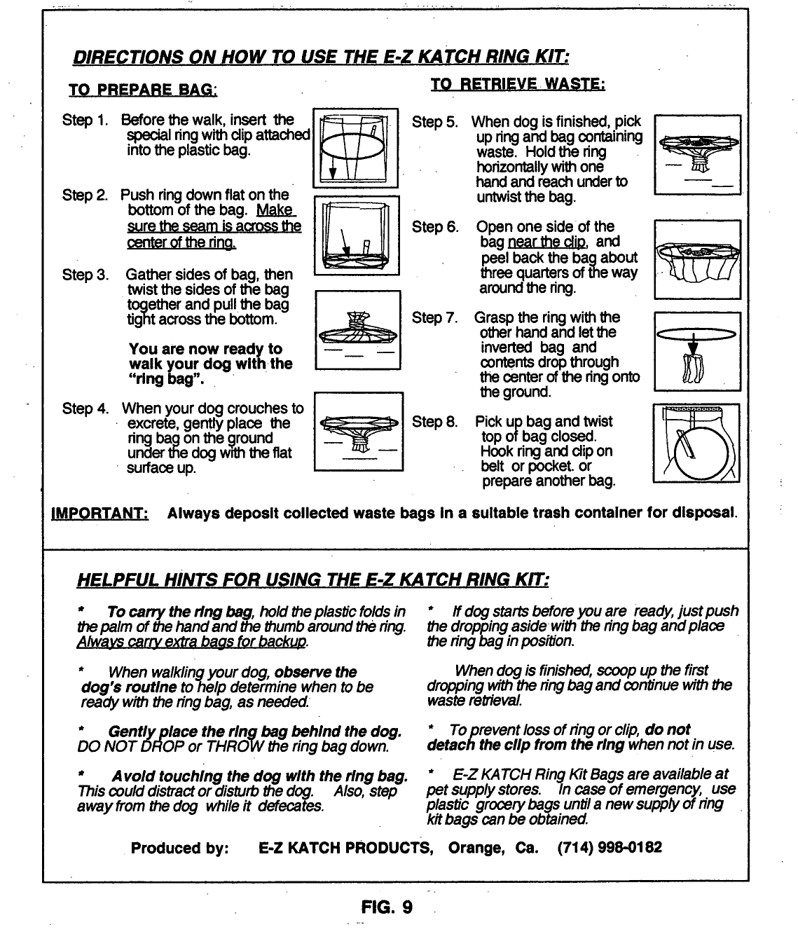

FIG. 9 displays the backpanel of the Ring Kit and all the information and drawings which are provided as an essential as part of the Ring Kit, referred to in claims 6 through 10. The top portion of FIG. 9 is printed with yellow background (not shown) and contains the step-by step directions and illustrations on How to Prepare and Use the Ring Kit Canine Waste Collection Method. The lower portion of FIG. 9 is printed with green background (not shown) and contains Helpful Hints for Using the Ring Kit

1. A canine waste collection device called a “ring bag” comprising a chrome-plated, 10-inch in diameter steel ring inside a disposable plastic bag. The steel ring inside provides shape and structure to the plastic bag. In preparation, the sides of the bag are gathered and twisted around on one side of the ring. The bottom of the bag on the other side of the ring forms a flat surface to catch the droppings.
The ring bag is assembled prior to walking the dog and is carried in one hand during the walk. A few moments before defecation, the ring bag is carefully placed behind and under the dog with the flat surface up.
As the dog finishes defecating and moves away from the ring bag, the ring bag is picked up and held horizontally so that the droppings remain on the flat surface. The under side of the plastic bag is then opened and as tension is released, the weight of the feces causes the bag to collapse and drop through the center of the ring.
The plastic bag has now been inverted capturing the waste inside. The bag is retrieved from the ground and sealed to prevent any contact with the waste material.

2. A canine waste collection device, called a “ring bag”, as claimed in claim 1, that uses a 10-inch steel ring and disposable plastic bag, which is easy to reload in ten seconds during the walk, if needed.

3. A canine waste collection device, called a “ring bag”, as claimed in claim 1, that uses a 10-inch steel ring which holds the ring bag flat on the ground. The ring bag will remain in place where it is positioned behind and under the dog. The flat profile of the ring bag avoids any contact with the dog. The presence of the ring bag is unnoticeable and does not frighten or distract the dog while it is defecating.

4. A canine waste collection device, called a “ring bag”, as claimed in claim 1, that uses a 10-inch steel ring which has been selected as the optimum size ring to be used to collect the waste droppings from any size dog. Also, under this patent, I also reserve the option to use different size steel rings in the ring kit, if the need should develop in the future. The concept of the ring bag would be the same.

5. A canine waste collection device, called a “ring bag”, as claimed in claim 1, uses a chrome-plated, 10-inch in diameter, 9-gauge steel ring. The steel ring weighs 2.5 ounces which is sufficient weight to hold the bag flat on the ground, where it is placed behind the dog, and to withstand wind currents of up to 25 mph.

6. A canine waste collection device, called a “ring kit”, that includes the ring bag, as claimed in claim 1, and also contains additional features related to this function. These additional features consist of a steel belt clip, a packet of 12 plastic bags, and specific instructions and helpful hints on how to use the ring kit for canine waste collection.

7. A canine waste collection device called a “ring kit”, as claimed in claim 6, that contains one packet of 12 disposable plastic bags of specific size and shape. The dimensions of the ring kit plastic bags are size 12×7×14 inches and is a three dimensional gusseted type bag. The size and shape of the gusseted plastic bags have tested functionally as the optimum size and shape for the ring kit that uses the 10-inch ring.

8. A canine waste collection device called a “ring kit”, as claimed in claim 6 that provides opaque white disposable plastic bags for the most sanitary appearance and high Disability, to discourage improper disposal of the bags containing waste material. Also, under this patent, I reserve the option to use other colors or designer type bags in the ring kit, if the need should develop in the future. The concept of the ring bag would be the same.

9. A canine waste collection device called a “ring kit”, as claimed in claim 6, that includes a 3×⅝inch, flat, folded steel belt clip. The belt clip should be attached to the steel ring at all times to prevent loss of the steel ring during the walk with the dog. After the canine waste is collected, the belt clip with the ring is hooked securely to the belt or pocket to continue the walk.

10. A canine waste collection device called a “ring kit”, as claimed in claim 6, that provides Special Instructions and Helpful Hints on how the dog handler should use this method for maximum results. Without this information, the basic idea and technique of using this method would not be apparent to most dog owners or dog handlers. The Special Instructions and Helpful Hints are printed on the back cardboard display panel provided with the ring kit. I claim the ideas expressed in the Special Instructions and Helpful Hints section of the ring kit constitute an essential part of the ring kit method and should be protected for use under this patent.
